(19) United States
(12) Patent Application Publication
(10) Pub. No.: US 2004/0111500 A1
(43) Pub. Date: Jun. 10, 2004

(54) System and method for commissioning a unit into a networked control system

(75) Inventor: Ronald Richard Rayburn, Norman, OK (US)

Correspondence Address: MCNEES, WALLACE & NURICK, 100 PINE STREET, P.O. BOX 1166, HARRISBURG, PA, 17108-1166, US

(73) Assignee: York International Corporation, York, PA

(21) Appl. No.: 10/315,900

(22) Filed: Dec. 10, 2002

(51) Int. Cl. G06F 15/177

(52) U.S. Cl. 709/222; 700/276

(57) ABSTRACT

A system and method is provided for an HVAC or refrigeration unit to obtain an appropriate address in order to commission the unit into a networked controls system. The units are assigned a predetermined address at the factory. After the unit is installed and is wired into the control network, a single action can be taken by an operator to commission the unit into the network. In commissioning the unit into the network, a valid address has to be obtained for the unit. A valid address is obtained for the unit by sequentially checking addresses on the network until an available address is located. Once an available address is located, the available address is assigned to the unit and the control system is notified of the address to commission the unit into the network.

### FIELD OF THE INVENTION

The present invention relates generally to commissioning units into a networked control system. More specifically, the present invention relates to assigning, in a single action, an address to a refrigeration or HVAC unit controlled by a networked control system.

### BACKGROUND OF THE INVENTION

The operation and monitoring of a refrigeration or heating, ventilating and air conditioning (HVAC) unit is generally performed by a control system. The control system can be used to control the operation of the unit, e.g. the starting and stopping of the unit and the opening and closing of valves in the unit. The control system can also be used for monitoring the operation of the unit, e.g. receiving and processing temperature, pressure or flow measurements and transmitting alarms and warnings to an operator. The control system is frequently implemented as a software program or algorithm that is executed by a computer or microprocessor. Further, each of the units has to be linked to the computer or processor with the control system in order to be controlled by the control system. This linking of the units to the computer or processor can have several different forms, including a star network, i.e. an individual connection of each unit to the control system computer, a ring network, i.e. the units are connected or networked to one another in a closed loop which includes the control system computer, or a bus network, i.e. the units are connected to a main communication line which is connected to the control system computer. In each of these different types of networks, for the control system to identify each of the units, the unit has to have a specific address to identify the unit to the control system. When one control system is being installed or implemented for multiple units, each of the units can be assigned a specific address for the control system to identify and communicate with the individual unit.

While it can be relatively simple to assign addresses to units when a control system is being implemented, it can be more complicated and time consuming to add or remove units in a control system after the control system has been implemented and is operational. One way to address a unit was to manually enter an address using a series of dipswitches. However, the use of dipswitches can make it very difficult to add a unit to the control system because the person installing the unit has to know what addresses have been previously entered for the other units in the control system and then assign and enter an address for the new unit based on what addresses have already been used. Another way is to activate a button on the unit and then go to the control system computer and have the control system computer scan the communication bus for the unit with its button depressed and then assign an address to that unit. This process is also difficult and time consuming because the installer has to press a button on the unit and then activate a routine or program on the control system computer to detect the unit and assign an address on the communication bus for the unit. As both of these techniques are very complicated and time consuming, a person installing the unit typically will not have the expertise to incorporate a new unit into an existing control system and frequently will require a controls specialist to incorporate the newly installed unit into the control system.

In addition to the above techniques, there are other techniques that can be used to assign an address to a device in a control system. U.S. Pat. No. 5,530,896 is directed to a process for addressing a functional unit connected to other functional units via bi-directional communication space. The process is used for matching a remote control unit to a working appliance. The process begins with a user selecting a matching button on a remote control unit to match the remote control unit to a working appliance. Next, the user has to select a specific control button on the remote control unit for matching. The control button will then be allocated two addresses, a network address (common to all working appliances for the control button) and a unit address (specific to one working appliance). The control button can be assigned a network address by selecting another control button on a second remote control unit. This causes the control button to be programmed to be assigned the network address of the other control button that was selected. Alternatively, the user may wish to select a network, having a new network address, for the control button. To assign a new network address, the process begins by transmitting a status request regarding the first possible address and awaits a response. If a response is received, the possible address is incremented and a status request for the incremented address is transmitted. The process is repeated until no response is received. If no response is received, the address is retransmitted and subsequently assigned to the control button if no response is received the second time. After a network address is assigned, a unit address is determined in a similar manner with the exception that two identical unit addresses can be used so long as the network addresses are different. Once the control button is completely addressed, the control button transmits a message requesting matching and stating the network address. The user can then select a working appliance to match to the control button by selecting a button on the working appliance. The working appliance is then assigned the network address of the control button and begins a scan to determine the unit address. After determining a unit address, the working appliance transmits a message to the control button containing the network address and the unit address of the working appliance. After being programmed, the control button can be used to control the working appliance. One drawback of this technique is that it is used for programming a remote control device and requires the assigning of two separate addresses. Another drawback is that multiple buttons have to be pressed on the remote control unit to obtain an address. A further drawback of this technique is that it is directed to the determination of an address for a one to one communication between a remote control unit and a working appliance and not for determining an address of a device on a networked control system.

U.S. Pat. No. 4,910,658 is directed to a system for monitoring and controlling elements of a process. A plurality of serially addressable control modules are connected to a multi-conductor cable, which also acts as a bus, and are connected to the unit to be controlled. The modules are readily connected or removed from the cable to permit expansion or modification. Modules are internally assigned a desired address to identify the corresponding unit and to assign priority among the units. After a unit has been added to the bus or cable and assigned a desired address through the module, the control unit is programmed to include the particular address, permitting the control unit to communicate with the unit. One drawback of this technique is the requirement for separate control modules having predetermined addresses in order to add or remove units to the control network.

U.S. Pat. No. 5,675,830 is directed to a system for assigning addresses to devices in a control network. A connectivity map is used to define an expected address for each device in the system and is stored in an I/O controller. The I/O controller downloads the connectivity map to an I/O bus manager during an addressing activity. The I/O bus manager checks to see if any devices do not have addresses assigned to them or have double addresses assigned to them. For unassigned addresses the I/O bus manager waits for the cluster unit of the device to request an address. The I/O bus manager assigns an address based on the next lowest available address. The cluster unit then confirms this address by displaying the address and the I/O bus manager then updates the connectivity map to indicate that the defined address has been assigned. One drawback of this technique is the requirement of a complicated connectivity map and I/O controllers and I/O bus managers to assign an address to a unit.

U.S. Pat. No. 5,615,106 sets forth a control device having a plurality of base components connected together in series by a signal line having a plurality of address lines. A control unit is connected to one base component and a plurality of controlled units are connected to the remaining base components. The base components associated with the controlled units are provided with terminators corresponding to one of the address signal lines, which terminators are then connected to the controlled unit. The remaining address signal lines are permitted to continue to the next base component. Addresses of the units are assigned by sequentially selecting address lines and then transmitting an address signal over the selected address line to the corresponding controlled unit, which then has an address that corresponds to the address signal.

U.S. Pat. No. 5,233,510 is directed to a continuously self-configuring distributed control system. The system can scan a plurality of potential address codes to locate an active object. If an active object has an address that matches the address code, an identity code corresponding to the object is returned to the system. The identity code and signal information for the object are then added to a machine map which is used to track active objects. The above process is repeated until all potential address codes have been scanned and the corresponding information is added to the machine map. Information in the machine map can then be updated by rescanning the potential address codes at a predetermined interval and adding and removing information as appropriate. For example, if a potential address code matches an address in the machine map, but no identity code is received, then the object is no longer active and the corresponding information is removed from the machine map.

Therefore, what is needed is a system and method for assigning an address to a unit on a networked control system that can be quickly and easily implemented and that does not require the use of external devices, external software programs or the control system computer to determine the unit's address on the network.

### SUMMARY OF THE INVENTION

One embodiment of the present invention is directed to a method for assigning an address to a unit connected to a control network. The method includes the steps of the unit generating a test address for the unit and transmitting a first data packet including the test address to all other units connected to the control network. Next, the method determines that the unit has not received a second data packet from one of the other units connected to the control network. The second data packet is a reply to the transmission of the first data packet. In response to a determination that the unit has not received a second data packet, the method then determines if the first data packet has been transmitted a predetermined number of times to all other units connected to the control network. The steps of transmitting a first data packet and determining that the unit has not received a second data packet are repeated in response to a determination that the first data packet has not been transmitted the predetermined number of times to all other units connected to the control network. Finally, the test address included in the first data packet is assigned to the unit in response to a determination that the first data packet has been transmitted the predetermined number of times to all other units connected to the control network.

Another embodiment of the present invention is directed to a heating, ventilation, air conditioning and refrigeration system. The system includes a plurality of heating, ventilation, air conditioning and refrigeration units and a controller to control operation of the plurality of heating, ventilation, air conditioning and refrigeration units. A network connects the plurality of heating, ventilation, air conditioning and refrigeration units to each other and to the controller. The network is configured to permit communication between the controller and the plurality of heating, ventilation, air conditioning and refrigeration units and to permit communication between heating, ventilation, air conditioning and refrigeration units. Each heating, ventilation, air conditioning and refrigeration unit has an addressing device to generate an address for that heating, ventilation, air conditioning unit for use by the controller and a single action mechanism to activate the addressing device.

One advantage of the present invention is that units can be easily commissioned onto a networked control system in a single action without the need for a specialist in control systems.

Another advantage of the present invention is that a unit can determine its own address on a control network without the assistance of an external device or software program.

A further advantage of the present invention is that units can easily be added, removed or replaced in the control system without having to reassign addresses to the other units in the control system.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates schematically one embodiment of a control network for units utilizing the addressing process of the present invention.

FIG. 2 illustrates a flow chart of the process of the present invention for obtaining an address for a unit.

FIG. 3 illustrates schematically another embodiment of a control network for units utilizing the addressing process of the present invention.

Wherever possible, the same reference numbers will be used throughout the drawings to refer to the same or like parts.

### DETAILED DESCRIPTION OF THE INVENTION

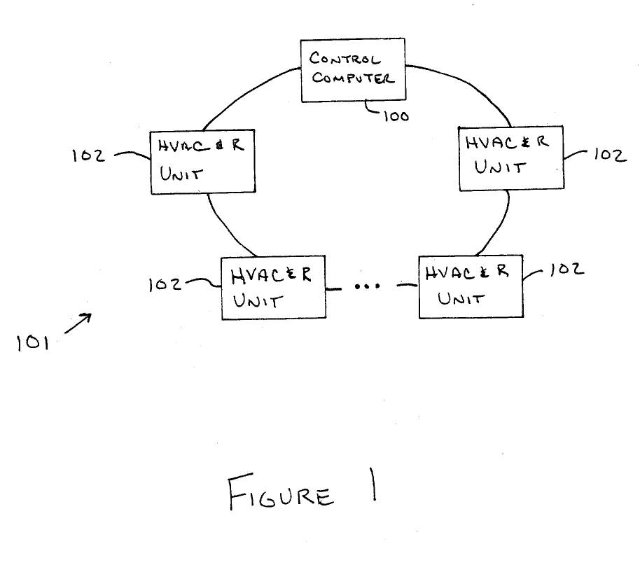

FIG. 1 illustrates schematically an arrangement of the system of the present invention. A control computer 100 is connected, over a network 101, to a plurality of units 102 controlled by the control computer 100. In a preferred embodiment of the present invention, the units 102 are preferably heating, ventilation, air conditioning and refrigeration (“HVAC&R”) units 102 or any other similar type of unit. However, the addressing process of the present invention can be utilized to assign an address to any device or unit 102 connected to a control network. As shown in FIG. 1, several HVAC&R units 102 are connected to the same control computer 100. The HVAC&R units 102 can be placed in any location, such as on a rooftop, within a building, or next to a building, provided that the HVAC&R unit 102 can be connected to the network 101 and the control computer 100. The HVAC&R unit 102 can be connected to the network 101 using a hard-wired connection or, alternatively, with a wireless connection.

The configuration of network 101 is preferably a ring or daisy chain configuration connecting each HVAC&R unit 102 to another HVAC&R unit 102, which ring or daisy chain is then connected to or includes the control computer 100 as shown in FIG. 1. In the ring or daisy chain configuration of the network 101, messages are preferably passed from one node to the next node in a predetermined direction. The nodes are the components connected to the network 101, in this embodiment, the nodes would be HVAC&R units 102 and control computer 100. When a message or data packet is received at a node, the node checks the destination address of the message or data packet and accepts the message if the destination address matches the node's address, otherwise the node regenerates the message or data packet and sends it to the next node.

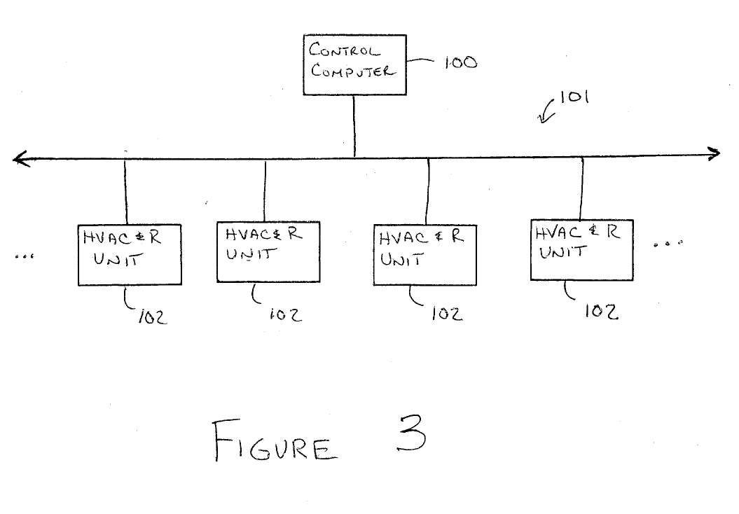

However, the configuration of network 101 can be a bus configuration connecting each HVAC&R unit 102 to a common communication line, which communication line is then connected to the control computer 100, as shown in FIG. 3, or a star configuration connecting each HVAC&R unit 102 directly to the control computer 100.

As mentioned above, the interconnection between HVAC&R units 102 can use either wireless connections, for example, infrared (IR) or radio frequency (RF) transmitters, receivers or transceivers, or hard-wired connections, for example, a three-wire cable or a RS-485 communication bus. However, it is to be understood that any suitable network configuration that permits the control computer 100 to communicate with the HVAC&R units 102 can be used.

The control computer 100 can be any type of general purpose computer having memory or storage devices (e.g. RAM, ROM, hard disk, CD-ROM, etc.), processing units (e.g. CPU, ALU, etc.) and input/output devices (e.g. monitor, keyboard, mouse, printer, etc.). The general purpose computer may also have communication devices (e.g. modems, network cards, etc.) for connecting or linking the general purpose computer to the network 101. In a preferred embodiment of the present invention, the control computer 100 stores and executes control system software or programs for monitoring the HVAC&R units 102 for alarm conditions or signals. The control software can, on a predetermined time interval, scan each HVAC&R unit 102 for the presence of an alarm condition. Alternatively, the control software can scan or listen to the network 101 for the presence of an alarm signal or condition broadcast by one of the HVAC&R units 102. Upon the detection of an alarm signal from one of the HVAC&R units 102, the control software can notify a user of the alarm or, possibly, take a corrective action. For example, the control software can take a corrective action to shut down a HVAC&R unit 102 in response to the receipt of a signal from that HVAC&R unit 102. In order to be able to detect and distinguish alarm signals or conditions from the HVAC&R units 102, the control software has to be able to distinguish between the individual HVAC&R units 102, preferably by utilizing a unique address that corresponds to a particular HVAC&R unit 102. In another embodiment of the present invention, the control software or programs can be used for more complex monitoring and controlling of the operation of the HVAC&R units 102. The control software of this embodiment is able to function with each HVAC&R unit 102 individually by providing individual instructions to each HVAC&R unit 102 and by receiving and identifying individual signals from each HVAC&R unit 102. Finally, it is to be understood that the control system software or programs executed by the control computer 100 can be any suitable type of control programming used for the control of HVAC&R units.

While the control computer 100 is shown separate from the HVAC&R units 102 in FIG. 1, it is to be understood that the control computer 100 can be incorporated into a HVAC&R unit 102 and then connected to the other HVAC&R units 102 by the network 101. Furthermore, in another embodiment of the present invention, the control computer 100 can be a microprocessor that executes the control system or a circuit board with appropriate circuitry and programming to provide a control system function.

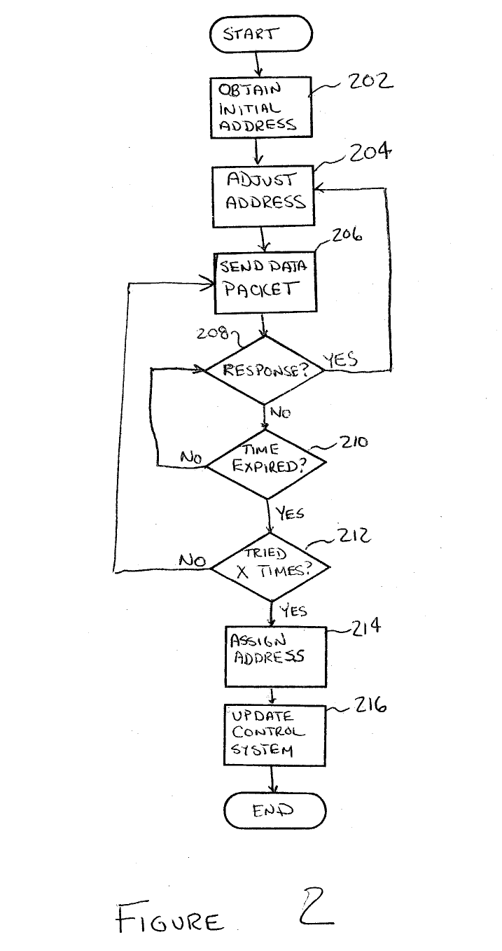

FIG. 2 illustrates a flowchart of the process for determining and assigning an address to an uncommissioned HVAC&R unit 102 and then commissioning the uncommissioned HVAC&R unit 102 into the control system. In a preferred embodiment of the present invention, each HVAC&R unit 102 in the control system can implement or execute the process of FIG. 2 in response to a single action taken by a person, such as the person activating a mechanism or pressing a button on the HVAC&R unit 102. The process of FIG. 2 can be implemented as a software program or routine that is stored on each HVAC&R unit 102 and executed by a module or device on the HVAC&R unit 102 having a microprocessor and a corresponding hardware devices. The hardware devices can include memory devices for storing the software or computer program and other information and communication devices (modems, network cards, etc.) for permitting the addressing module or device to communicate over the network 101 with the control computer 100 and the other HVAC&R units 102. Alternatively, the process of FIG. 2 can be implemented as a hardware solution on a circuit board(s) incorporated into the HVAC&R unit 102 for use with the addressing module. The addressing process of FIG. 2 can be used with any type of network 101 used for controlling HVAC&R units 102.

The process for determining and assigning an address to an uncommissioned HVAC&R unit 102 to commission the uncommissioned HVAC&R unit 102 into the control system begins at step 202 where an initial address for the uncommissioned HVAC&R unit 102 is obtained. The initial address for the uncommissioned HVAC&R unit 102 is preassigned and stored in the uncommissioned HVAC&R unit 102, preferably in the memory device of the addressing module. In a preferred embodiment of the present invention, each HVAC&R unit 102 in the control system has the same initial preassigned address. However, each HVAC&R unit 102 in the control system can also have a different initial preassigned address.

In step 204, the initial preassigned address is adjusted by a predetermined amount to obtain a test address. The initial preassigned address can be either incremented or decremented, depending on the initial preassigned address that has been selected, to obtain the test address. For example, in one embodiment of the present invention, the initial preassigned address is 01 in hexadecimal (Hex) and the initial preassigned address is to be incremented by one to obtain the test address. In this example, at the completion of step 204, the test address is 02 Hex (01 Hex+01 Hex). The amount of increment or decrement applied to an address to obtain the test address is dependent on the total number of addresses available, the particular counting scheme used and any particular requirements of the control system.

In step 206, the test address obtained from step 204 is included in a data packet and sent over the network 101 to the other HVAC&R units 102 in the control system to query or determine if the test address generated in step 204 is assigned to or in use by another HVAC&R unit 102. The data packet or query data packet with the test address can be sent or transmitted to each HVAC&R unit 102 substantially simultaneously or can be provided sequentially to each HVAC&R unit 102, depending on the configuration of the network 101, to determine if one of the HVAC&R units 102 in the control system is using the test address in the query data packet. In addition to the test address, the query data packet can include other information such as function codes and register information to associate the query data packet to an address determination query command.

In another embodiment of the present invention, the initial preassigned address stored in the uncommissioned HVAC&R unit 102 can be included in the query data packet and sent over the network 101 in step 206 instead of the test address thereby bypassing step 204. In this embodiment, the initial preassigned address is available for assignment to a unit and provides the maximum number of addresses available for assignment to HVAC&R units 102.

In step 208, the uncommissioned HVAC&R unit 102 determines if a data packet with a response or reply has been received from another HVAC&R unit 102 in the control system indicating that the HVAC&R unit 102 has been previously assigned the test address included in the query data packet. The reply data packet includes the test address and other information such as function codes and register information relating the reply data packet to an address determination reply command. The reply data packet also preferably uses the same protocols as the ones used by the query data packet. If the uncommissioned HVAC&R unit 102 determines that a reply data packet has been received, the uncommissioned HVAC&R unit 102 then returns to step 204 of the process and adjusts the test address by the predetermined amount and sends another query data packet in step 206 with the adjusted test address.

If the uncommissioned HVAC&R unit 102 has not received a reply data packet, the process moves to step 210 to determine if a predetermined timeout period has expired. The predetermined time period can be any suitable period of time that permits a HVAC&R unit 102 to receive the query data packet and send a reply data packet. If the predetermined timeout period has not expired, the uncommissioned HVAC&R unit 102 returns to step 208 to determine if a response has been received. Additionally, the uncommissioned HVAC&R unit 102 can calculate or determine if an error or collision has occurred after sending the query data packet and can retry sending the query data packet with the test address using a collision method in response to a collision determination.

If the predetermined timeout period has expired in step 208, the uncommissioned HVAC&R unit 102 then determines in step 212 if the test address has been attempted or tried a predetermined number of times without a response. In one embodiment of the present invention, the predetermined number of times without a response can be four times without a response before an address is assigned to the uncommissioned HVAC&R unit 102. If the test address has not been attempted the predetermined number of times without a response, the uncommissioned HVAC&R unit 102 returns to step 206 and resends or retransmits the query data packet with the same test address. If the test address has been attempted the predetermined number of times without a response in step 212, the uncommissioned HVAC&R unit 102 is assigned the address from the query data packet in step 214. Finally, after the uncommissioned HVAC&R unit 102 is assigned the address from step 214, the control software stored on the control computer 100 is notified of the address for the uncommissioned HVAC&R unit 102 thereby commissioning the HVAC&R unit 102 into the control network.

This process can be repeated for each HVAC&R unit 102 that is included in the control network for the control system. In addition, HVAC&R units 102 can easily be added to the control network for the control system at a later time by connecting the HVAC&R unit 102 to the network 101 and initiating the address determination and assignment process illustrated in FIG. 2. The address assignment process can be used to add new HVAC&R units 102 to the control network or alternatively, be used to substitute one HVAC&R unit 102 for another HVAC&R unit 102.

To further illustrate the address determination process, the following example is provided. A control system is controlling three units. Unit 1 has an address of 02 Hex, unit 2 has an address of 03 Hex and unit 3 has an address of 04 Hex. A user then connects a fourth unit to the network for control by the control system. The fourth unit has an initial preassigned address of 01 Hex. The user initiates the address determination process by activating a control on the fourth unit. Unit 4 initiates the address determination process and increments the initial preassigned address to obtain a test address of 02 Hex. The test address (02 Hex) is then sent in a query data packet over the network to the other units. Unit 1 sends a reply data packet to unit 4 indicating that the test address (02 Hex) is in use and is not available.

Unit 4 then increments the prior test address (02 Hex) to obtain a new test address (03 Hex) according to the address determination process. The test address (03 Hex) is then sent in a query data packet over the network to the other units. Unit 2 sends a reply data packet to unit 4 indicating that the test address (03 Hex) is in use and is not available. Unit 4 then increments the prior test address (03 Hex) to obtain a new test address (04 Hex) according to the address determination process. The test address (04 Hex) is then sent in a query data packet over the network to the other units. Unit 3 sends a reply data packet to unit 4 indicating that the test address (04 Hex) is in use and is not available.

Unit 4 then increments the prior test address (04 Hex) to obtain a new test address (05 Hex) according to the address determination process. The test address (05 Hex) is then sent in a query data packet over the network to the other units. As none of the other units is assigned the test address (05 Hex) no reply data packet is returned to unit 4. After a predetermined time period has elapsed with no reply packet being received, unit 4 resends the query data packet with the test address (05 Hex) to the other units. If no response is received within the predetermined time period, unit 4 repeats this process two more times and then assigns itself the address of 05 Hex for the control system, if no response is received either time. Unit 4 then notifies the control system of its address, thereby commissioning unit 4 into the control network for control by the control system.

In another embodiment of the present invention, when the uncommissioned HVAC&R unit 102 provides the control system with address information in step 216 of the address determination process of FIG. 2, the uncommissioned HVAC&R unit 102 can also provide the control system with additional information. For example, a serial number of the HVAC&R unit 102 can be provided with the unit's address to the control system. In addition, the make and model of the HVAC&R unit 102 can be provided with the unit's address to the control system. The additional information received by the control system can then be incorporated into information provided to the user of the control system to permit the user of the control system to more easily identify the particular HVAC&R units 102 controlled by the control system.

In another embodiment of the present invention, the HVAC&R unit 102 can be programmed with options to permit a user to do a variety of different tasks once an address is assigned to the HVAC&R unit 102. For example, the HVAC&R unit 102 can be programmed to display the address of the unit by activating the control that was used to assign the address to the HVAC&R unit 102. In another example, the address of the unit can be reset by activating the control on the unit a predetermined number of times within a predetermined time period, e.g. pressing a control button twice in five seconds.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for assigning an address to a unit connected to a control network, the method comprising the steps of:
generating a test address for the unit;
transmitting a first data packet to all other units connected to the control network, wherein the first data packet includes the test address;
determining that the unit has not received a second data packet from one of the other units connected to the control network, wherein the second data packet being a reply to the transmission of the first data packet;
determining that the first data packet has been transmitted a predetermined number of times to all other units connected to the control network in response to a determination that the unit has not received a second data packet;
repeating the steps of transmitting a first data packet and determining that the unit has not received a second data packet in response to a determination that the first data packet has not been transmitted the predetermined number of times to all other units connected to the control network; and
assigning the test address included in the first data packet to the unit in response to a determination that the first data packet has been transmitted the predetermined number of times to all other units connected to the control network.

2. The method of claim 1 further comprising the steps of:
adjusting the test address in response to a determination that the unit has received a second data packet from one of the other units connected to the control network; and
retransmitting the first data packet including the adjusted test address to all other units connected to the control network in response to an adjustment of the test address.

3. The method of claim 2 wherein the step of adjusting the test address includes the step of incrementing the test address by a predetermined amount.

4. The method of claim 2 wherein the step of adjusting the test address includes the step of decrementing the test address by a predetermined amount.

5. The method of claim 1 wherein the step of generating a test address includes the step of retrieving a predetermined address from a memory device of the unit.

6. The method of claim 5 wherein the step of generating a test address further includes the step of adjusting the predetermined address by a predetermined amount.

7. The method of claim 6 wherein the step of adjusting the predetermined address by a predetermined amount includes the step of incrementing the predetermined address by the predetermined amount.

8. The method of claim 7 wherein the predetermined address is 01 Hex and the predetermined amount is 01 Hex.

9. The method of claim 1 wherein the step of determining that the unit has not received a second data packet from one of the other units includes the step of waiting a predetermined period of time for receipt of the second data packet.

10. The method of claim 1 wherein:
the step of transmitting a first data packet to all other units connected to the control network includes the step of querying all other units connected to the control network to determine the availability of the test address included in the first data packet; and
the step of determining that the unit has not received a second data packet from one of the other units connected to the control network includes the step of receiving a second data packet from one unit of the other units connected to the control network indicating that the one unit of the other units connected to the control network is assigned the test address included in the first data packet.

11. The method of claim 1 wherein the step of determining that the first data packet has been transmitted a predetermined number of times to all other units connected to the control network includes the step of determining that the first data packet has been transmitted four times to all other units connected to the control network.

12. The method of claim 1 wherein the step of generating a test address for the unit includes the step of activating a mechanism on the unit by a user.

13. A heating, ventilation, air conditioning and refrigeration system comprising:
a plurality of heating, ventilation, air conditioning and refrigeration units;
a controller to control operation of the plurality of heating, ventilation, air conditioning and refrigeration units;
a network to connect the plurality of heating, ventilation, air conditioning and refrigeration units to each other and to the controller, the network being configured to permit communication between the controller and the plurality of heating, ventilation, air conditioning and refrigeration units and the network being configured to permit communication between heating, ventilation, air conditioning and refrigeration units; and
wherein each heating, ventilation, air conditioning and refrigeration unit includes an addressing device to generate an address for that heating, ventilation, air conditioning unit for use by the controller and a single action mechanism to activate the addressing device.

14. The system of claim 13 wherein each addressing device comprises a processor to execute a program to assign an address for that heating, ventilation, air conditioning and refrigeration unit and communication means for permitting the addressing device to communicate with other heating, ventilation, air conditioning and refrigeration units and the controller.

15. The system of claim 14 wherein the addressing device further comprises a memory device to store an initial address for the heating, ventilation, air conditioning and refrigeration unit.

16. The system of claim 14 wherein the communication means comprises wireless communication means.

17. The system of claim 13 wherein the addressing device comprises:
means for generating an address for that heating, ventilation, air conditioning and refrigeration unit;
means for transmitting an address to other heating, ventilation, air conditioning and refrigeration units of the plurality of heating, ventilation, air conditioning and refrigeration units;
means for receiving a response from a heating, ventilation, air conditioning and refrigeration unit of the plurality of heating, ventilation, air conditioning and refrigeration units located at the address transmitted by the means for transmitting; and
means for assigning the address transmitted by the means for transmitting to that heating, ventilation, air conditioning and refrigeration unit upon the means for receiving a response not receiving a response after a predetermined number of transmissions of the address by the means for transmitting.

18. The system of claim 13 wherein the single action mechanism is a pushbutton located on the heating, ventilation, air conditioning and refrigeration unit.

19. The system of claim 13 wherein the network has a daisy chain configuration.

20. A computer program product embodied on a computer readable medium and executable by a microprocessor for assigning an address to a unit connected to a control network, the computer program product comprising computer instructions for executing the steps of:
generating a test address for the unit;
transmitting a first data packet to all other units connected to the control network, wherein the first data packet includes the test address;
determining that the unit has not received a second data packet from one of the other units connected to the control network, wherein the second data packet being a reply to the transmission of the first data packet;
determining that the first data packet has been transmitted to all other units connected to the control network a predetermined number of times in response to a determination that the unit has not received a second data packet;
repeating the steps of transmitting a first data packet and determining that the unit has not received a second data packet in response to a determination that the first data packet has not been transmitted the predetermined number of times to all other units connected to the control network; and
assigning the test address included in the first data packet to the unit in response to a determination that the first data packet has been transmitted the predetermined number of times to all other units connected to the control network.

21. A method for commissioning a unit into a control system for controlling a plurality of units, the method comprising the steps of:
generating an address for use by the unit;
querying all other units in the control system to determine the availability of the address for use by the unit, wherein the query includes the address for use by the unit;
waiting a predetermined time period for a reply from one unit of all other units indicating that the address included in the query is presently in use by the one unit of all other units;
determining a number of querying attempts for the address included in the query in response to the expiration of the predetermined time period;
comparing the number of querying attempts to a predetermined amount;
repeating the steps of querying all other units and waiting a predetermined time period in response to the number of querying attempts not being equal to the predetermined amount;
assigning the address included in the query to the unit in response to the number of querying attempts being equal to the predetermined amount; and
transmitting to the control system the assigned address of the unit to commission the unit into the control system.

22. The method of claim 21 further comprising the steps of:
adjusting the address in response to the unit receiving a reply from one unit of all other units indicating that the address is presently in use by the one unit of all other units; and
querying all other units in the control system to determine the availability of the adjusted address for use by the unit, wherein the query includes the adjusted address.

23. The method of claim 22 wherein the step of adjusting the address includes the step of incrementing the address by a predetermined amount.

24. The method of claim 22 wherein the step of adjusting the address includes the step of decrementing the address by a predetermined amount.

25. The method of claim 21 wherein the step of generating an address includes the step of retrieving a predetermined address from a memory device of the unit.

26. The method of claim 25 wherein the step of generating an address further includes the step of adjusting the predetermined address by a predetermined amount.

27. The method of claim 21 wherein the step of generating an address for the unit includes the step of activating a mechanism on the unit by a user.
